(19) United States
(12) Patent Application Publication
(10) Pub. No.: US 2007/0064018 A1
(43) Pub. Date: Mar. 22, 2007

(54) Detail-in-context lenses for online maps

(75) Inventors: Garth B.D. Shoemaker, Vancouver (CA); David J.P. Baar, Vancouver (CA)

Correspondence Address: MCCARTHY TETRAULT LLP, BOX 48, SUITE 4700,, 66WELLINGTON STREET WEST, TORONTO, ON, M5K 1E6, CA

(73) Assignee: Idelix Software Inc., Vancouver (CA)

(21) Appl. No.: 11/473,152

(22) Filed: Jun. 23, 2006

Related U.S. Application Data
(60) Provisional application No. 60/693,411, filed on Jun. 24, 2005.

(51) Int. Cl. G09G 5/00

(52) U.S. Cl. 345/660

(57) ABSTRACT

A method for providing a presentation of a region-of-interest within an original image to a client, the original image being stored in a content server coupled to a proxy server and the client over a network, the method comprising: in response to a request from the client for the presentation, receiving at the proxy server the original image from the content server; applying a lens to the original image to produce the presentation at the proxy server, the lens having a focal region with a magnification for the region-of-interest at least partially surrounded by a shoulder region where the magnification diminishes; and, sending the presentation to the client. In addition, a method for generating a presentation of search results pertaining to a geographic area for display on a display screen, comprising: receiving a signal selecting a search result from the search results, the search result having a location within the geographic area; and, applying a lens to an original map image for the geographic area to produce the presentation, the lens having a focal region with a magnification for the location at least partially surrounded by a shoulder region where the magnification diminishes. Furthermore, a method for generating a presentation of a path from a first location to a second location in a geographic area for display on a display screen, comprising: displaying an original map image for the geographic area having an overlaid representation of the path; receiving a signal selecting a location on the original map image, wherein the location is limited to at least one of being on the representation of the path and being within a predetermined distance from the representation of the path; and, applying a lens to the original map image to produce the presentation, the lens having a focal region with a magnification for the location at least partially surrounded by a shoulder region where the magnification diminishes.

This application claims priority from U.S. Provisional Patent Application No. 60/693,411, filed Jun. 24, 2005, and incorporated herein by reference.

### FIELD OF THE INVENTION

This invention relates to the field of computer graphics processing, and more specifically, to a method and system for applying detail-in-context lenses to online maps and mapping applications.

### BACKGROUND OF THE INVENTION

Modern computer graphics systems, including virtual environment systems, are used for numerous applications such as online digital mapping, navigation, surveillance, and even playing computer games. In general, these applications are launched by the computer graphics system's operating system upon selection by a user from a menu or other graphical user interface (“GUI”). A GUI is used to convey information to and receive commands from users and generally includes a variety of GUI objects or controls, including icons, toolbars, drop-down menus, text, dialog boxes, buttons, and the like. A user typically interacts with a GUI by using a pointing device (e.g., a mouse) to position a pointer or cursor over an object and “clicking” on the object.

One problem with these computer graphics systems is their inability to effectively display detailed information for selected graphic objects when those objects are in the context of a larger image. A user may require access to detailed information with respect to an object in order to closely examine the object, to interact with the object, or to interface with an external application or network through the object. For example, the detailed information may be a close-up view of the object or a region of a digital map image in an online mapping system.

While an application may provide a GUI for a user to access and view detailed information for a selected object in a larger image, in doing so, the relative location of the object in the larger image may be lost to the user. Thus, while the user may have gained access to the detailed information required to interact with the object, the user may lose sight of the context within which that object is positioned in the larger image. This is especially so when the user must interact with the GUI using a computer mouse or keyboard. The interaction may further distract the user from the context in which the detailed information is to be understood. This problem is an example of what is often referred to as the “screen real estate problem”.

A need therefore exists for an improved method and system for adjusting detailed views of selected information within the context of surrounding information presented on the display of a computer graphics system. Accordingly, a solution that addresses, at least in part, the above and other shortcomings is desired.

### SUMMARY OF THE INVENTION

According to one aspect of the invention, there is provided a method for providing a presentation of a region-of-interest within an original image to a client, the original image being stored in a content server coupled to a proxy server and the client over a network, the method comprising: in response to a request from the client for the presentation, receiving at the proxy server the original image from the content server; applying a lens to the original image to produce the presentation at the proxy server, the lens having a focal region with a magnification for the region-of-interest at least partially surrounded by a shoulder region where the magnification diminishes; and, sending the presentation to the client.

In the above method, the original image may include one or more tile images. The lens may be applied to tile images corresponding to the region-of-interest to produce lensed tile images and the presentation may be produced by combining the lensed tile images with tile images corresponding to the original image beyond the region-of-interest. The original image may be a map image. The method may further include receiving one or more signals from the client to adjust the lens. The client may be adapted to display the presentation on a display screen. The step of applying may further include displacing the original image onto the lens to produce a displacement and perspectively projecting the displacement onto a plane in a direction aligned with a viewpoint for the region-of-interest. The client may be adapted to receive the one or more signals through a graphical user interface (“GUI”) displayed over the lens in the presentation. The GUI may have means for adjusting the lens and at least some of the means may be icons. And, the network may be the Internet, the content server may be a web browser server, and the client may be a web browser.

According to another aspect of the invention, there is provided a method for generating a presentation of search results pertaining to a geographic area for display on a display screen, comprising: receiving a signal selecting a search result from the search results, the search result having a location within the geographic area; and, applying a lens to an original map image for the geographic area to produce the presentation, the lens having a focal region with a magnification for the location at least partially surrounded by a shoulder region where the magnification diminishes.

The method may further include displaying the presentation on the display screen. The method may further include inserting an icon into the presentation at the location to highlight the location. The original map image may be an online map image. The presentation may be displayed in a first window on the display screen and the search results may be displayed in a second window on the display screen. The original map image may include one or more text labels and the method may further include relocating at least one text label appearing within the lens to within the focal region of the lens to improve legibility of the at least one text label. The method may further include adjusting a font size of the at least one text label within the focal region to improve legibility of the at least one text label. The signal may be received from a pointing device manipulated by a user. The signal may be generated from a ranking of the search results. The method may further include inserting information pertaining to the search result into the presentation within the lens. The information may be one or more of a text message, a telephone number, an email address, an advertisement, and a street address. The method may further include receiving one or more signals to adjust at least one of a size, a shape, and the magnification of the focal region. The method may further include receiving the one or more signals through a graphical user interface (“GUI”) displayed over the lens. The GUI may have means for adjusting at least one of the size, shape, and magnification of the focal region. At least some of the means may be icons. The means for adjusting the size and shape may be at least one handle icon positioned on a perimeter of the focal region. The means for adjusting the magnification may be a slide bar icon. The method may further include receiving one or more signals through a GUI displayed over the lens to adjust at least one of a size and a shape of the shoulder region, wherein the GUI has one or more handle icons positioned on a perimeter of the shoulder region for adjusting at least one of the size and the shape of the shoulder region. The step of applying may further include displacing the original image onto the lens to produce a displacement and perspectively projecting the displacement onto a plane in a direction aligned with a viewpoint for the region-of-interest. And, the search results may be generated by an online search engine.

According to another aspect of the invention, there is provided a method for generating a presentation of a path from a first location to a second location in a geographic area for display on a display screen, comprising: displaying an original map image for the geographic area having an overlaid representation of the path; receiving a signal selecting a location on the original map image, wherein the location is limited to at least one of being on the representation of the path and being within a predetermined distance from the representation of the path; and, applying a lens to the original map image to produce the presentation, the lens having a focal region with a magnification for the location at least partially surrounded by a shoulder region where the magnification diminishes.

The method may further include displaying the presentation on the display screen. The signal may be received from a global positioning system (“GPS”) receiver. The signal may be received from a pointing device manipulated by a user. The signal may be a sequence of signals for moving the lens through a respective sequence of locations. The step of applying may further include displacing the original map image onto the lens to produce a displacement and perspectively projecting the displacement onto a plane in a direction aligned with a viewpoint for the location. The method may further include receiving one or more signals to adjust the lens through a graphical user interface (“GUI”) displayed over the lens, wherein the GUI has means for adjusting at least one of a size, a shape, and the magnification of the focal region, wherein the means for adjusting the size and shape is at least one handle icon positioned on a perimeter of the focal region, and wherein the means for adjusting the magnification is a slide bar icon. The method may further include receiving one or more signals through the GUI to adjust at least one of a size and a shape of the shoulder region, wherein the GUI has one or more handle icons positioned on a perimeter of the shoulder region for adjusting at least one of the size and the shape of the shoulder region. The location may be limited to at least one of being on a representation of a street intersection on the original map image and being within a predetermined distance from the representation of the street intersection on the original map image. And, the signal may be received from a pointing device manipulated by a user over a listing of street intersections including an item corresponding to the representation of the street intersection.

In accordance with further aspects of the present invention there is provided an apparatus such as a data processing system (e.g., client, server, proxy server, content server, etc.), a method for adapting this system, as well as articles of manufacture such as a computer readable medium having program instructions recorded thereon for practising the method of the invention.

### BRIEF DESCRIPTION OF THE DRAWINGS

Further features and advantages of the embodiments of the present invention will become apparent from the following detailed description, taken in combination with the appended drawings, in which:

FIG. 1 is a graphical representation illustrating the geometry for constructing a three-dimensional perspective viewing frustum, relative to an x, y, z coordinate system, in accordance with elastic presentation space graphics technology and an embodiment of the invention;

FIG. 2 is a graphical representation illustrating the geometry of a presentation in accordance with elastic presentation space graphics technology and an embodiment of the invention;

FIG. 3 is a block diagram illustrating a data processing system adapted for implementing an embodiment of the invention;

FIG. 4 is a partial screen capture illustrating a GUI having lens control elements for user interaction with detail-in-context data presentations in accordance with an embodiment of the invention;

FIG. 5 is a screen capture illustrating a detail-in-context presentation in which a lens is coupled to search results and is applied to an online map in accordance with an embodiment of the invention;

FIG. 6 is a screen capture illustrating an online map having cluttered data and labels in accordance with an embodiment of the invention;

FIG. 7 is a screen capture illustrating a detail-in-context presentation of the online map of FIG. 6 in which de-cluttering is provided in the lens in accordance with an embodiment of the invention; and,

FIG. 8 is a flowchart illustrating operations of modules within the memory of a proxy server for providing a presentation of a region-of-interest within an original image to a client, the original image being stored in a content server coupled to the proxy server and the client over a network, in accordance with an embodiment of the invention.

It will be noted that throughout the appended drawings, like features are identified by like reference numerals.

### DETAILED DESCRIPTION OF THE PREFERRED EMBODIMENTS

In the following description, details are set forth to provide an understanding of the invention. In some instances, certain software, circuits, structures and methods have not been described or shown in detail in order not to obscure the invention. The term “data processing system” is used herein to refer to any machine for processing data, including the computer systems and network arrangements described herein. The present invention may be implemented in any computer programming language provided that the operating system of the data processing system provides the facilities that may support the requirements of the present invention. Any limitations presented would be a result of a particular type of operating system or computer programming language and would not be a limitation of the present invention.

The “screen real estate problem” generally arises whenever large amounts of information are to be displayed on a display screen of limited size. Known tools to address this problem include panning and zooming. While these tools are suitable for a large number of visual display applications, they become less effective where sections of the visual information are spatially related, such as in layered maps and three-dimensional representations, for example. In this type of information display, panning and zooming are not as effective as much of the context of the panned or zoomed display may be hidden.

A recent solution to this problem is the application of “detail-in-context” presentation techniques. Detail-in-context is the magnification of a particular region-of-interest (the “focal region” or “detail”) in a data presentation while preserving visibility of the surrounding information (the “context”). This technique has applicability to the display of large surface area media (e.g. digital maps) on computer screens of variable size including graphics workstations, laptop computers, personal digital assistants (“PDAs”), and cell phones.

In the detail-in-context discourse, differentiation is often made between the terms “representation” and “presentation”. A representation is a formal system, or mapping, for specifying raw information or data that is stored in a computer or data processing system. For example, a digital map of a city is a representation of raw data including street names and the relative geographic location of streets and utilities. Such a representation may be displayed visually on a computer screen or printed on paper. On the other hand, a presentation is a spatial organization of a given representation that is appropriate for the task at hand. Thus, a presentation of a representation organizes such things as the point of view and the relative emphasis of different parts or regions of the representation. For example, a digital map of a city may be presented with a region magnified to reveal street names.

In general, a detail-in-context presentation may be considered as a distorted view (or distortion) of a portion of the original representation or image where the distortion is the result of the application of a “lens” like distortion function to the original representation. A detailed review of various detail-in-context presentation techniques such as “Elastic Presentation Space” (“EPS”) (or “Pliable Display Technology” (“PDT”)) may be found in a publication by Marianne S. T. Carpendale, entitled “A Framework for Elastic Presentation Space” (Carpendale, Marianne S. T., A Framework for Elastic Presentation Space (Burnaby, British Columbia: Simon Fraser University, 1999)), and incorporated herein by reference.

In general, detail-in-context data presentations are characterized by magnification of areas of an image where detail is desired, in combination with compression of a restricted range of areas of the remaining information (i.e., the context), the result typically giving the appearance of a lens having been applied to the display surface. Using the techniques described by Carpendale, points in a representation are displaced in three dimensions and a perspective projection is used to display the points on a two-dimensional presentation display. Thus, when a lens is applied to a two-dimensional continuous surface representation, for example, the resulting presentation appears to be three-dimensional. In other words, the lens transformation appears to have stretched the continuous surface in a third dimension. In EPS graphics technology, a two-dimensional visual representation is placed onto a surface; this surface is placed in three-dimensional space; the surface, containing the representation, is viewed through perspective projection; and the surface is manipulated to effect the reorganization of image details. The presentation transformation is separated into two steps: surface manipulation or distortion and perspective projection.

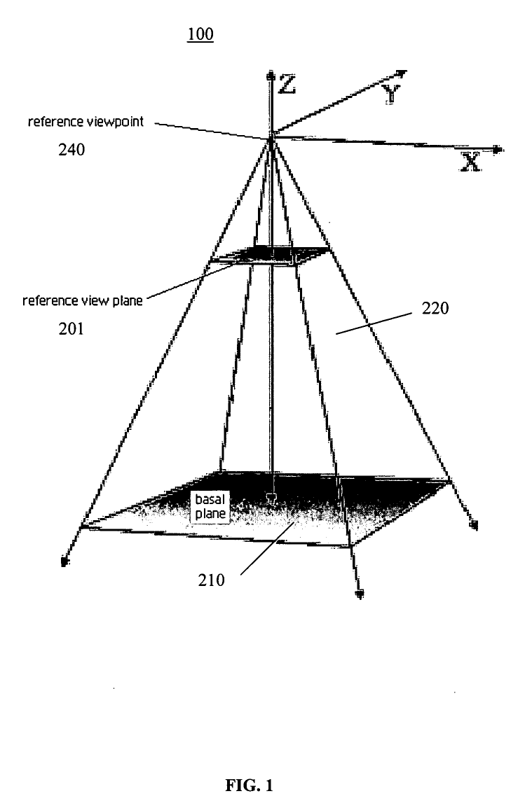

FIG. 1 is a graphical representation illustrating the geometry 100 for constructing a three-dimensional (“3D”) perspective viewing frustum 220, relative to an x, y, z coordinate system, in accordance with elastic presentation space (EPS) graphics technology and an embodiment of the invention. In EPS technology, detail-in-context views of two-dimensional (“2D”) visual representations are created with sight-line aligned distortions of a 2D information presentation surface within a 3D perspective viewing frustum 220. In EPS, magnification of regions of interest and the accompanying compression of the contextual region to accommodate this change in scale are produced by the movement of regions of the surface towards the viewpoint (“VP”) 240 located at the apex of the pyramidal shape 220 containing the frustum. The process of projecting these transformed layouts via a perspective projection results in a new 2D layout which includes the zoomed and compressed regions. The use of the third dimension and perspective distortion to provide magnification in EPS provides a meaningful metaphor for the process of distorting the information presentation surface. The 3D manipulation of the information presentation surface in such a system is an intermediate step in the process of creating a new 2D layout of the information.

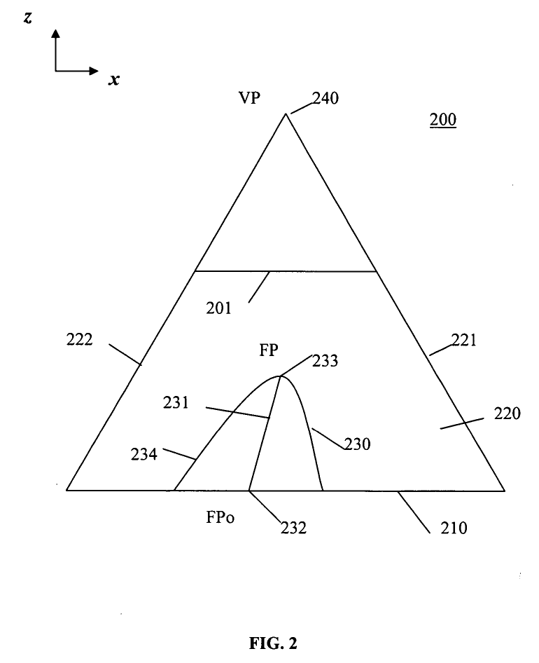

FIG. 2 is a graphical representation illustrating the geometry 200 of a presentation in accordance with EPS graphics technology and an embodiment of the invention. EPS graphics technology employs viewer-aligned perspective projections to produce detail-in-context presentations in a reference view plane 201 which may be viewed on a display. Undistorted 2D data points are located in a base plane 210 of a 3D perspective viewing volume or frustum 220 which is defined by extreme rays 221 and 222 and the base plane 210. The VP 240 is generally located above the centre point of the base plane 210 and reference view plane (“RVP”) 201. Points in the base plane 210 are displaced upward onto a distorted surface or “lens” 230 which is defined by a general 3D distortion function (i.e., a detail-in-context distortion basis function). The direction of the perspective projection corresponding to the distorted surface 230 is indicated by the line FPo-FP 231 drawn from a point FPo 232 in the base plane 210 through the point FP 233 which corresponds to the focal point, focus, or focal region 233 of the distorted surface or lens 230. Typically, the perspective projection has a uniform direction 231 that is viewer-aligned (i.e., the points FPo 232, FP 233, and VP 240 are collinear).

EPS is applicable to multidimensional data and is well suited to implementation on a computer for dynamic detail-in-context display on an electronic display surface such as a monitor. In the case of two dimensional data, EPS is typically characterized by magnification of areas of an image where detail is desired 233, in combination with compression of a restricted range of areas of the remaining information (i.e., the context) 234, the end result typically giving the appearance of a lens 230 having been applied to the display surface. The areas of the lens 230 where compression occurs may be referred to as the “shoulder” 234 of the lens 230. The area of the representation transformed by the lens may be referred to as the “lensed area”. The lensed area thus includes the focal region 233 and the shoulder region 234. To reiterate, the source image or representation to be viewed is located in the base plane 210. Magnification 233 and compression 234 are achieved through elevating elements of the source image relative to the base plane 210, and then projecting the resultant distorted surface onto the reference view plane 201. EPS performs detail-in-context presentation of n-dimensional data through the use of a procedure wherein the data is mapped into a region in an (n+1) dimensional space, manipulated through perspective projections in the (n+l) dimensional space, and then finally transformed back into n-dimensional space for presentation. EPS has numerous advantages over conventional zoom, pan, and scroll technologies, including the capability of preserving the visibility of information outside 210,234 the local region of interest 233.

For example, and referring to FIGS. 1 and 2, in two dimensions, EPS can be implemented through the projection of an image onto a reference plane 201 in the following manner. The source image or representation is located on a base plane 210, and those regions of interest 233 of the image for which magnification is desired are elevated so as to move them closer to a reference plane situated between the reference viewpoint 240 and the reference view plane 201. Magnification of the focal region 233 closest to the RVP 201 varies inversely with distance from the RVP 201. As shown in FIGS. 1 and 2, compression of regions 234 outside the focal region 233 is a function of both distance from the RVP 201, and the gradient of the function (i.e., the shoulder function or drop-off function) describing the vertical distance from the RVP 201 with respect to horizontal distance from the focal region 233. The resultant combination of magnification 233 and compression 234 of the image as seen from the reference viewpoint 240 results in a lens-like effect similar to that of a magnifying glass applied to the image. Hence, the various functions used to vary the magnification and compression of the source image via vertical displacement from the base plane 210 are described as lenses, lens types, or lens functions. Lens functions that describe basic lens types with point and circular focal regions, as well as certain more complex lenses and advanced capabilities such as folding, have previously been described by Carpendale.

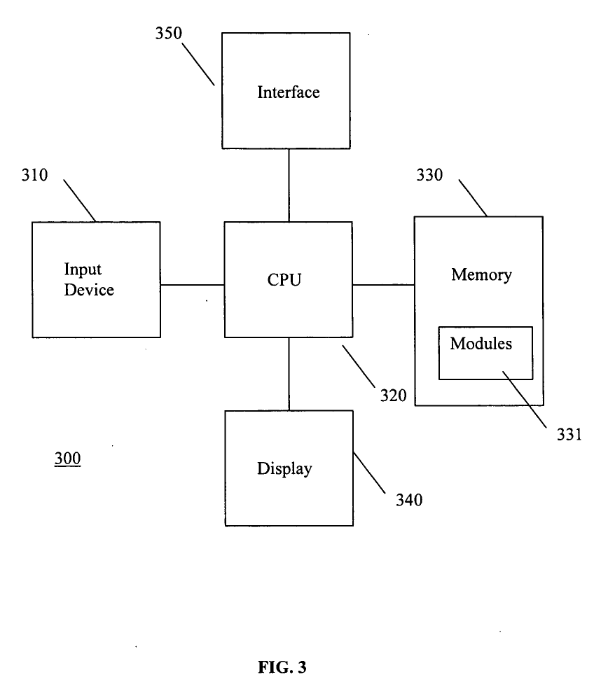

FIG. 3 is a block diagram illustrating a data processing system 300 adapted for implementing an embodiment of the invention. The data processing system 300 is suitable for implementing EPS technology, for displaying detail-in-context presentations of representations in conjunction with a detail-in-context graphical user interface (GUI) 400, as described below, and for adjusting detail-in-context lenses in detail-in-context presentations for online mapping applications. The data processing system 300 includes an input device 310, a central processing unit (“CPU”) 320, memory 330, a display 340, and an interface 350. The input device 310 may include a keyboard, a mouse, a pen and tablet, a trackball, a position tracking device, an eye tracking device, or a similar device.

The CPU 320 may include dedicated coprocessors and memory devices. The memory 330 may include RAM, ROM, databases, or disk devices. The display 340 may include a computer screen, terminal device, or a hardcopy producing output device such as a printer or plotter. And, the interface 350 may include an interface to the Internet and/or to another wired or wireless network (not shown). The data processing system 300 may be linked to other data processing systems (not shown) by a network (not shown) through the interface 350. For example, the data processing system 300 may be a client and/or server in a client/server system. The data processing system 300 has stored therein data representing sequences of instructions which when executed cause the method described herein to be performed. Of course, the data processing system 300 may contain additional software and hardware a description of which is not necessary for understanding the invention.

Thus, the data processing system 300 includes computer executable programmed instructions for directing the system 300 to implement the embodiments of the present invention. The programmed instructions may be embodied in one or more hardware or software modules 331 resident in the memory 330 of the data processing system 300. Alternatively, the programmed instructions may be embodied on a computer readable medium (such as a CD disk or floppy disk) which may be used for transporting the programmed instructions to the memory 330 of the data processing system 300. Alternatively, the programmed instructions may be embedded in a computer-readable, signal or signal-bearing medium that is uploaded to a network by a vendor or supplier of the programmed instructions, and this signal or signal-bearing medium may be downloaded through an interface 350 to the data processing system 300 from the network by end users or potential buyers.

As mentioned, detail-in-context presentations of data using techniques such as pliable surfaces, as described by Carpendale, are useful in presenting large amounts of information on limited-size display surfaces. Detail-in-context views allow magnification of a particular region-of-interest (the “focal region”) 233 in a data presentation while preserving visibility of the surrounding information 210. In the following, a GUI 400 is described having lens control elements that can be implemented in software (and/or hardware) and applied to the control of detail-in-context data presentations. The software (and/or hardware) can be loaded into and run by the data processing system 300 of FIG. 3.

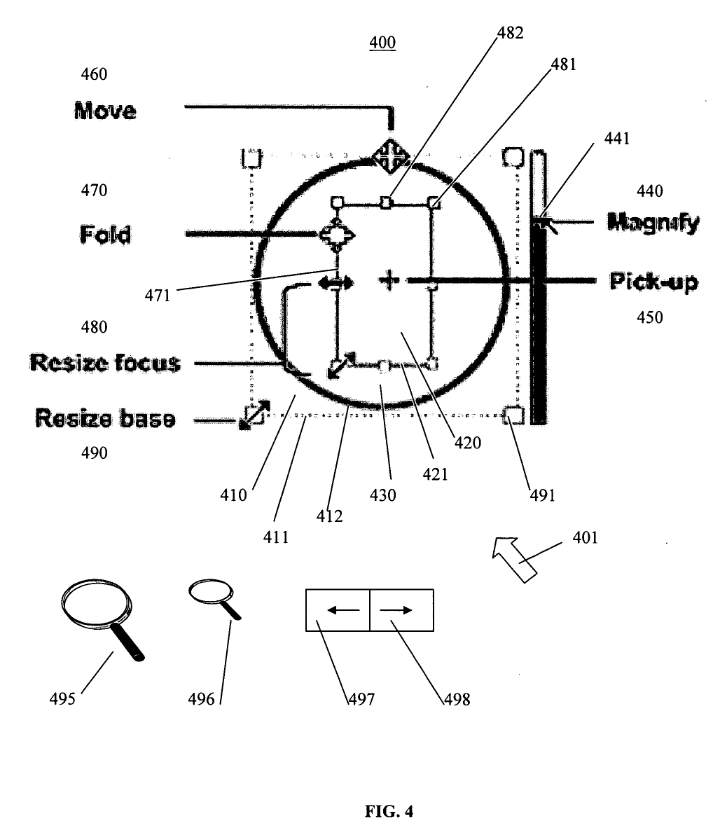

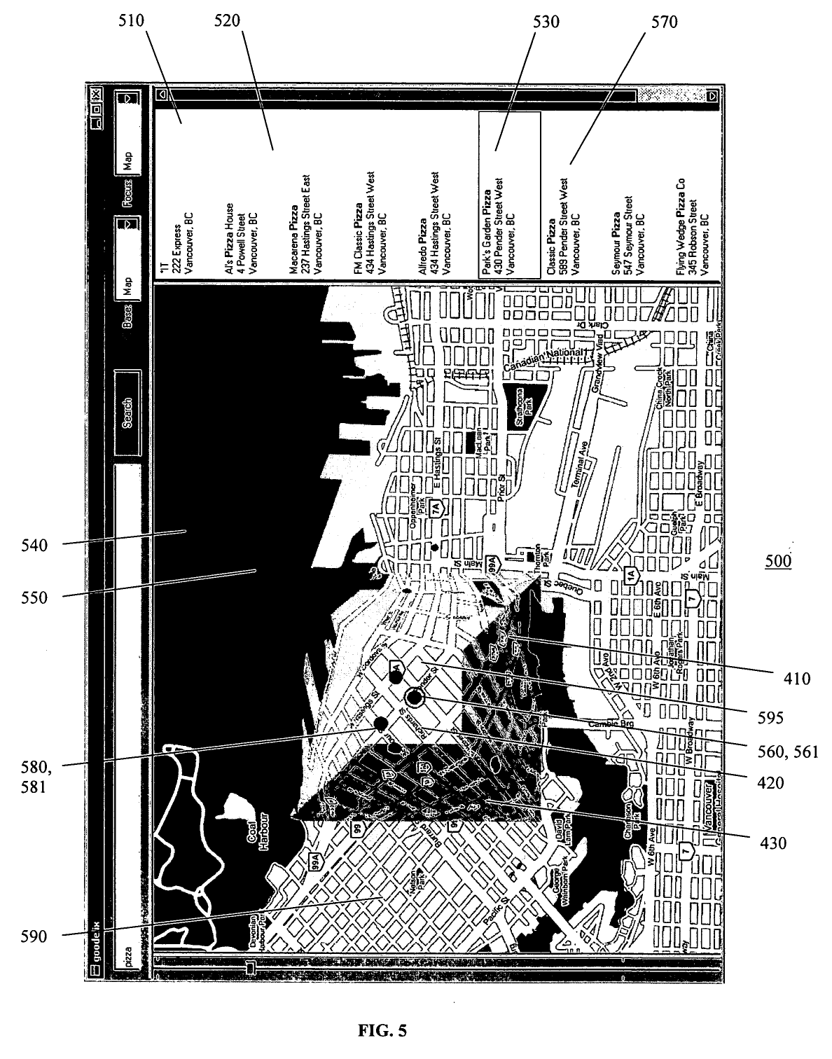

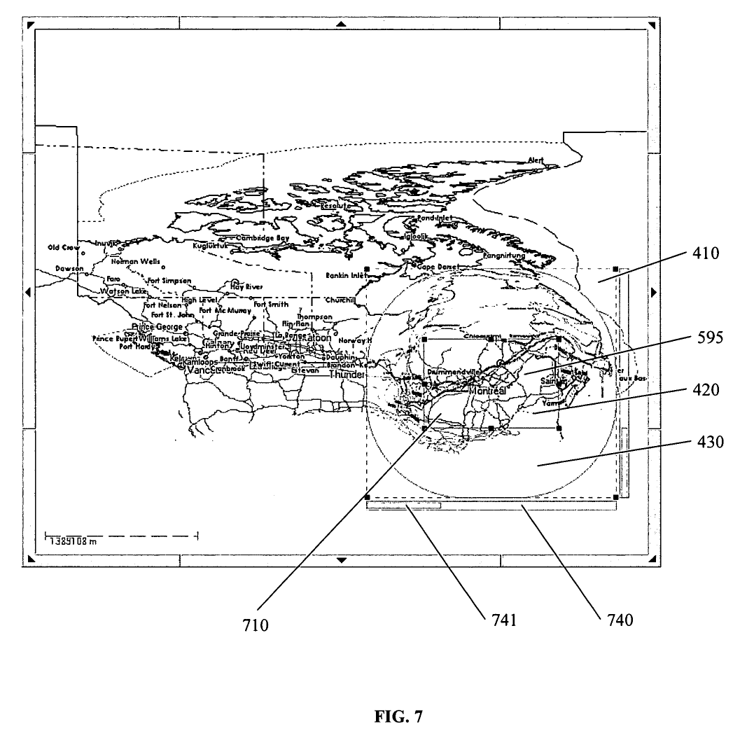

FIG. 4 is a partial screen capture illustrating a GUI 400 having lens control elements for user interaction with detail-in-context data presentations in accordance with an embodiment of the invention. Detail-in-context data presentations are characterized by magnification of areas of an image where detail is desired, in combination with compression of a restricted range of areas of the remaining information (i.e., the context), the end result typically giving the appearance of a lens having been applied to the display screen surface. This lens 410 includes a “focal region” 420 having high magnification, a surrounding “shoulder region” 430 where information is typically visibly compressed, and a “base” 412 surrounding the shoulder region 430 and defining the extent of the lens 410. In FIG. 4, the lens 410 is shown with a circular shaped base 412 (or outline) and with a focal region 420 lying near the center of the lens 410. However, the lens 410 and focal region 420 may have any desired shape. For example, in FIG. 5 the lens 410 has an truncated pyramidal shape while in FIG. 7 the lens 410 has an oblong shape. As mentioned above, the base of the lens 412 may be coextensive with the focal region 420.

In general, the GUI 400 has lens control elements that, in combination, provide for the interactive control of the lens 410. The effective control of the characteristics of the lens 410 by a user (i.e., dynamic interaction with a detail-in-context lens) is advantageous. At any given time, one or more of these lens control elements may be made visible to the user on the display surface 340 by appearing as overlay icons on the lens 410. Interaction with each element is performed via the motion of an input or pointing device 310 (e.g., a mouse) with the motion resulting in an appropriate change in the corresponding lens characteristic. As will be described, selection of which lens control element is actively controlled by the motion of the pointing device 310 at any given time is determined by the proximity of the icon representing the pointing device 310 (e.g., a cursor) on the display surface 340 to the appropriate component of the lens 410. For example, “dragging” of the pointing device at the periphery of the bounding rectangle of the lens base 412 causes a corresponding change in the size of the lens 410 (i.e., “resizing”). Thus, the GUI 400 provides the user with a visual representation of which lens control element is being adjusted through the display of one or more corresponding icons.

For ease of understanding, the following discussion will be in the context of using a two-dimensional pointing device 310 that is a mouse, but it will be understood that the invention may be practiced with other 2D or 3D (or even greater numbers of dimensions) input devices including a trackball, a keyboard, a position tracking device, an eye tracking device, an input from a navigation device, etc.

A mouse 310 controls the position of a cursor icon 401 that is displayed on the display screen 340. The cursor 401 is moved by moving the mouse 310 over a flat surface, such as the top of a desk, in the desired direction of movement of the cursor 401. Thus, the two-dimensional movement of the mouse 310 on the flat surface translates into a corresponding two-dimensional movement of the cursor 401 on the display screen 340.

A mouse 310 typically has one or more finger actuated control buttons (i.e., mouse buttons). While the mouse buttons can be used for different functions such as selecting a menu option pointed at by the cursor 401, the disclosed invention may use a single mouse button to “select” a lens 410 and to trace the movement of the cursor 401 along a desired path. Specifically, to select a lens 410, the cursor 401 is first located within the extent of the lens 410. In other words, the cursor 401 is “pointed” at the lens 410. Next, the mouse button is depressed and released. That is, the mouse button is “clicked”. Selection is thus a point and click operation. To trace the movement of the cursor 401, the cursor 401 is located at the desired starting location, the mouse button is depressed to signal the computer 320 to activate a lens control element, and the mouse 310 is moved while maintaining the button depressed. After the desired path has been traced, the mouse button is released. This procedure is often referred to as “clicking” and “dragging” (i.e., a click and drag operation). It will be understood that a predetermined key on a keyboard 310 could also be used to activate a mouse click or drag. In the following, the term “clicking” will refer to the depression of a mouse button indicating a selection by the user and the term “dragging” will refer to the subsequent motion of the mouse 310 and cursor 401 without the release of the mouse button.

The GUI 400 may include the following lens control elements: move, pickup, resize base, resize focus, fold, magnify, zoom, and scoop. Each of these lens control elements has at least one lens control icon or alternate cursor icon associated with it. In general, when a lens 410 is selected by a user through a point and click operation, the following lens control icons may be displayed over the lens 410: pickup icon 450, base outline icon 412, base bounding rectangle icon 411, focal region bounding rectangle icon 421, handle icons 481, 482, 491, magnify slide bar icon 440, zoom icon 495, and scoop slide bar icon 740 (see FIG. 7). Typically, these icons are displayed simultaneously after selection of the lens 410. In addition, when the cursor 401 is located within the extent of a selected lens 410, an alternate cursor icon 460, 470, 480, 490, 495 may be displayed over the lens 410 to replace the cursor 401 or may be displayed in combination with the cursor 401. These lens control elements, corresponding icons, and their effects on the characteristics of a lens 410 are described below with reference to FIGS. 4 and 7.

In general, when a lens 410 is selected by a point and click operation, bounding rectangle icons 411, 421 are displayed surrounding the base 412 and focal region 420 of the selected lens 410 to indicate that the lens 410 has been selected. With respect to the bounding rectangles 411, 421 one might view them as glass windows enclosing the lens base 412 and focal region 420, respectively. The bounding rectangles 411, 421 include handle icons 481, 482, 491 allowing for direct manipulation of the enclosed base 412 and focal region 420 as will be explained below. Thus, the bounding rectangles 411, 421 not only inform the user that the lens 410 has been selected, but also provide the user with indications as to what manipulation operations might be possible for the selected lens 410 though use of the displayed handles 481, 482, 491. Note that it is well within the scope of the present invention to provide a bounding region having a shape other than generally rectangular. Such a bounding region could be of any of a great number of shapes including oblong, oval, ovoid, conical, cubic, cylindrical, polyhedral, spherical, etc.

Moreover, the cursor 401 provides a visual cue indicating the nature of an available lens control element. As such, the cursor 401 will generally change in form by simply pointing to a different lens control icon 450, 412, 411, 421, 481, 482, 491, 440, 740. For example, when resizing the base 412 of a lens 410 using a corner handle 491, the cursor 401 will change form to a resize icon 490 once it is pointed at (i.e., positioned over) the corner handle 491. The cursor 401 will remain in the form of the resize icon 490 until the cursor 401 has been moved away from the corner handle 491.

Lateral movement of a lens 410 is provided by the move lens control element of the GUI 400. This functionality is accomplished by the user first selecting the lens 410 through a point and click operation. Then, the user points to a point within the lens 410 that is other than a point lying on a lens control icon 450, 412, 411, 421, 481, 482, 491, 440, 740. When the cursor 401 is so located, a move icon 460 is displayed over the lens 410 to replace the cursor 401 or may be displayed in combination with the cursor 401. The move icon 460 not only informs the user that the lens 410 may be moved, but also provides the user with indications as to what movement operations are possible for the selected lens 410. For example, the move icon 460 may include arrowheads indicating up, down, left, and right motion. Next, the lens 410 is moved by a click and drag operation in which the user clicks and drags the lens 410 to the desired position on the screen 340 and then releases the mouse button 310. The lens 410 is locked in its new position until a further pickup and move operation is performed.

Lateral movement of a lens 410 is also provided by the pickup lens control element of the GUI. This functionality is accomplished by the user first selecting the lens 410 through a point and click operation. As mentioned above, when the lens 410 is selected a pickup icon 450 is displayed over the lens 410 near the centre of the lens 410. Typically, the pickup icon 450 will be a crosshairs.

In addition, a base outline 412 is displayed over the lens 410 representing the base 412 of the lens 410. The crosshairs 450 and lens outline 412 not only inform the user that the lens has been selected, but also provides the user with an indication as to the pickup operation that is possible for the selected lens 410. Next, the user points at the crosshairs 450 with the cursor 401. Then, the lens outline 412 is moved by a click and drag operation in which the user clicks and drags the crosshairs 450 to the desired position on the screen 340 and then releases the mouse button 310. The full lens 410 is then moved to the new position and is locked there until a further pickup operation is performed. In contrast to the move operation described above, with the pickup operation, it is the outline 412 of the lens 410 that the user repositions rather than the full lens 410.

Resizing of the base 412 (or outline) of a lens 410 is provided by the resize base lens control element of the GUI. After the lens 410 is selected, a bounding rectangle icon 411 is displayed surrounding the base 412. For a rectangular shaped base 412, the bounding rectangle icon 411 may be coextensive with the perimeter of the base 412. The bounding rectangle 411 includes handles 491. These handles 491 can be used to stretch the base 412 taller or shorter, wider or narrower, or proportionally larger or smaller. The corner handles 491 will keep the proportions the same while changing the size. The middle handles (not shown) will make the base 412 taller or shorter, wider or narrower. Resizing the base 412 by the corner handles 491 will keep the base 412 in proportion. Resizing the base 412 by the middle handles will change the proportions of the base 412. That is, the middle handles change the aspect ratio of the base 412 (i.e., the ratio between the height and the width of the bounding rectangle 411 of the base 412). When a user points at a handle 491 with the cursor 401 a resize icon 490 may be displayed over the handle 491 to replace the cursor 401 or may be displayed in combination with the cursor 401. The resize icon 490 not only informs the user that the handle 491 may be selected, but also provides the user with indications as to the resizing operations that are possible with the selected handle. For example, the resize icon 490 for a corner handle 491 may include arrows indicating proportional resizing. The resize icon (not shown) for a middle handle may include arrows indicating width resizing or height resizing. After pointing at the desired handle 491 the user would click and drag the handle 491 until the desired shape and size for the base 412 is reached. Once the desired shape and size are reached, the user would release the mouse button 310. The base 412 of the lens 410 is then locked in its new size and shape until a further base resize operation is performed.

Resizing of the focal region 420 of a lens 410 is provided by the resize focus lens control element of the GUI. After the lens 410 is selected, a bounding rectangle icon 421 is displayed surrounding the focal region 420. For a rectangular shaped focal region 420, the bounding rectangle icon 421 may be coextensive with the perimeter of the focal region 420. The bounding rectangle 421 includes handles 481, 482. These handles 481, 482 can be used to stretch the focal region 420 taller or shorter, wider or narrower, or proportionally larger or smaller. The corner handles 481 will keep the proportions the same while changing the size. The middle handles 482 will make the focal region 420 taller or shorter, wider or narrower. Resizing the focal region 420 by the corner handles 481 will keep the focal region 420 in proportion. Resizing the focal region 420 by the middle handles 482 will change the proportions of the focal region 420. That is, the middle handles 482 change the aspect ratio of the focal region 420 (i.e., the ratio between the height and the width of the bounding rectangle 421 of the focal region 420). When a user points at a handle 481,482 with the cursor 401 a resize icon 480 may be displayed over the handle 481, 482 to replace the cursor 401 or may be displayed in combination with the cursor 401. The resize icon 480 not only informs the user that a handle 481, 482 may be selected, but also provides the user with indications as to the resizing operations that are possible with the selected handle. For example, the resize icon 480 for a corner handle 481 may include arrows indicating proportional resizing. The resize icon 480 for a middle handle 482 may include arrows indicating width resizing or height resizing. After pointing at the desired handle 481, 482, the user would click and drag the handle 481, 482 until the desired shape and size for the focal region 420 is reached. Once the desired shape and size are reached, the user would release the mouse button 310. The focal region 420 is then locked in its new size and shape until a further focus resize operation is performed.

Folding of the focal region 420 of a lens 410 is provided by the fold control element of the GUI. In general, control of the degree and direction of folding (i.e., skewing of the viewer aligned vector 231 as described by Carpendale) is accomplished by a click and drag operation on a point 471, other than a handle 481, 482, on the bounding rectangle 421 surrounding the focal region 420. The direction of folding is determined by the direction in which the point 471 is dragged. The degree of folding is determined by the magnitude of the translation of the cursor 401 during the drag. In general, the direction and degree of folding corresponds to the relative displacement of the focus 420 with respect to the lens base 410. In other words, and referring to FIG. 2, the direction and degree of folding corresponds to the displacement of the point FP 233 relative to the point FPo 232, where the vector joining the points FPo 232 and FP 233 defines the viewer aligned vector 231. In particular, after the lens 410 is selected, a bounding rectangle icon 421 is displayed surrounding the focal region 420. The bounding rectangle 421 includes handles 481, 482. When a user points at a point 471, other than a handle 481, 482, on the bounding rectangle 421 surrounding the focal region 420 with the cursor 401, a fold icon 470 may be displayed over the point 471 to replace the cursor 401 or may be displayed in combination with the cursor 401. The fold icon 470 not only informs the user that a point 471 on the bounding rectangle 421 may be selected, but also provides the user with indications as to what fold operations are possible. For example, the fold icon 470 may include arrowheads indicating up, down, left, and right motion. By choosing a point 471, other than a handle 481, 482, on the bounding rectangle 421 a user may control the degree and direction of folding. To control the direction of folding, the user would click on the point 471 and drag in the desired direction of folding. To control the degree of folding, the user would drag to a greater or lesser degree in the desired direction of folding. Once the desired direction and degree of folding is reached, the user would release the mouse button 310. The lens 410 is then locked with the selected fold until a further fold operation is performed.

Magnification of the lens 410 is provided by the magnify lens control element of the GUI. After the lens 410 is selected, the magnify control is presented to the user as a slide bar icon 440 near or adjacent to the lens 410 and typically to one side of the lens 410. Sliding the bar 441 of the slide bar 440 results in a proportional change in the magnification of the lens 410. The slide bar 440 not only informs the user that magnification of the lens 410 may be selected, but also provides the user with an indication as to what level of magnification is possible. The slide bar 440 includes a bar 441 that may be slid up and down, or left and right, to adjust and indicate the level of magnification. To control the level of magnification, the user would click on the bar 441 of the slide bar 440 and drag in the direction of desired magnification level. Once the desired level of magnification is reached, the user would release the mouse button 310. The lens 410 is then locked with the selected magnification until a further magnification operation is performed. In general, the focal region 420 is an area of the lens 410 having constant magnification (i.e., if the focal region is a plane). Again referring to FIGS. 1 and 2, magnification of the focal region 420, 233 varies inversely with the distance from the focal region 420, 233 to the reference view plane (RVP) 201. Magnification of areas lying in the shoulder region 430 of the lens 410 also varies inversely with their distance from the RVP 201. Thus, magnification of areas lying in the shoulder region 430 will range from unity at the base 412 to the level of magnification of the focal region 420.

Zoom functionality is provided by the zoom lens control element of the GUI. Referring to FIG. 2, the zoom lens control element, for example, allows a user to quickly navigate to a region of interest 233 within a continuous view of a larger presentation 210 and then zoom in to that region of interest 233 for detailed viewing or editing. Referring to FIG. 4, the combined presentation area covered by the focal region 420 and shoulder region 430 and surrounded by the base 412 may be referred to as the “extent of the lens”. Similarly, the presentation area covered by the focal region 420 may be referred to as the “extent of the focal region”. The extent of the lens may be indicated to a user by a base bounding rectangle 411 when the lens 410 is selected. The extent of the lens may also be indicated by an arbitrarily shaped figure that bounds or is coincident with the perimeter of the base 412. Similarly, the extent of the focal region may be indicated by a second bounding rectangle 421 or arbitrarily shaped figure. The zoom lens control element allows a user to: (a) “zoom in” to the extent of the focal region such that the extent of the focal region fills the display screen 340 (i.e., “zoom to focal region extent”); (b) “zoom in” to the extent of the lens such that the extent of the lens fills the display screen 340 (i.e., “zoom to lens extent”); or, (c) “zoom in” to the area lying outside of the extent of the focal region such that the area without the focal region is magnified to the same level as the extent of the focal region (i.e., “zoom to scale”).

In particular, after the lens 410 is selected, a bounding rectangle icon 411 is displayed surrounding the base 412 and a bounding rectangle icon 421 is displayed surrounding the focal region 420. Zoom functionality is accomplished by the user first selecting the zoom icon 495 through a point and click operation When a user selects zoom functionality, a zoom cursor icon 496 may be displayed to replace the cursor 401 or may be displayed in combination with the cursor 401. The zoom cursor icon 496 provides the user with indications as to what zoom operations are possible. For example, the zoom cursor icon 496 may include a magnifying glass. By choosing a point within the extent of the focal region, within the extent of the lens, or without the extent of the lens, the user may control the zoom function. To zoom in to the extent of the focal region such that the extent of the focal region fills the display screen 340 (i.e., “zoom to focal region extent”), the user would point and click within the extent of the focal region. To zoom in to the extent of the lens such that the extent of the lens fills the display screen 340 (i.e., “zoom to lens extent”), the user would point and click within the extent of the lens. Or, to zoom in to the presentation area without the extent of the focal region, such that the area without the extent of the focal region is magnified to the same level as the extent of the focal region (i.e., “zoom to scale”), the user would point and click without the extent of the lens. After the point and click operation is complete, the presentation is locked with the selected zoom until a further zoom operation is performed.

Alternatively, rather than choosing a point within the extent of the focal region, within the extent of the lens, or without the extent of the lens to select the zoom function, a zoom function menu with multiple items (not shown) or multiple zoom function icons (not shown) may be used for zoom function selection. The zoom function menu may be presented as a pull-down menu. The zoom function icons may be presented in a toolbar or adjacent to the lens 410 when the lens is selected. Individual zoom function menu items or zoom function icons may be provided for each of the “zoom to focal region extent”, “zoom to lens extent”, and “zoom to scale” functions described above. In this alternative, after the lens 410 is selected, a bounding rectangle icon 411 may be displayed surrounding the base 412 and a bounding rectangle icon 421 may be displayed surrounding the focal region 420. Zoom functionality is accomplished by the user selecting a zoom function from the zoom function menu or via the zoom function icons using a point and click operation. In this way, a zoom function may be selected without considering the position of the cursor 401 within the lens 410.

The concavity or “scoop” of the shoulder region 430 of the lens 410 is provided by the scoop lens control element of the GUI. After the lens 410 is selected, the scoop control is presented to the user as a slide bar icon 740 (see FIG. 7) near or adjacent to the lens 410 and typically below the lens 410. Sliding the bar 741 of the slide bar 740 results in a proportional change in the concavity or scoop of the shoulder region 430 of the lens 410. The slide bar 740 not only informs the user that the shape of the shoulder region 430 of the lens 410 may be selected, but also provides the user with an indication as to what degree of shaping is possible. The slide bar 740 includes a bar 741 that may be slid left and right, or up and down, to adjust and indicate the degree of scooping. To control the degree of scooping, the user would click on the bar 741 of the slide bar 740 and drag in the direction of desired scooping degree. Once the desired degree of scooping is reached, the user would release the mouse button 310. The lens 410 is then locked with the selected scoop until a further scooping operation is performed.

Advantageously, a user may choose to hide one or more lens control icons 450, 412, 411, 421, 481, 482, 491, 440, 495, 740 shown in FIGS. 4 and 7 from view so as not to impede the user's view of the image within the lens 410. This may be helpful, for example, during an editing or move operation. A user may select this option through means such as a menu, toolbar, or lens property dialog box.

In addition, the GUI 400 maintains a record of control element operations such that the user may restore pre-operation presentations. This record of operations may be accessed by or presented to the user through “Undo” and “Redo” icons 497,498, through a pull-down operation history menu (not shown), or through a toolbar.

Thus, detail-in-context data viewing techniques allow a user to view multiple levels of detail or resolution on one display 340. The appearance of the data display or presentation is that of one or more virtual lenses showing detail 233 within the context of a larger area view 210. Using multiple lenses in detail-in-context data presentations may be used to compare two regions of interest at the same time. Folding enhances this comparison by allowing the user to pull the regions of interest closer together. Moreover, using detail-in-context technology such as PDT, an area of interest can be magnified to pixel level resolution, or to any level of detail available from the source information, for in-depth review. The digital images may include graphic images, maps, photographic images, or text documents, and the source information may be in raster, vector, or text form.

For example, in order to view a selected object or area in detail, a user can define a lens 410 over the object using the GUI 400. The lens 410 may be introduced to the original image to form the a presentation through the use of a pull-down menu selection, tool bar icon, etc. Using lens control elements for the GUI 400, such as move, pickup, resize base, resize focus, fold, magnify, zoom, and scoop, as described above, the user adjusts the lens 410 for detailed viewing of the object or area. Using the magnify lens control element, for example, the user may magnify the focal region 420 of the lens 410 to pixel quality resolution revealing detailed information pertaining to the selected object or area. That is, a base image (i.e., the image outside the extent of the lens) is displayed at a low resolution while a lens image (i.e., the image within the extent of the lens) is displayed at a resolution based on a user selected magnification 440, 441.

In operation, the data processing system 300 employs EPS techniques with an input device 310 and GUI 400 for selecting objects or areas for detailed display to a user on a display screen 340. Data representing an original image or representation is received by the CPU 320 of the data processing system 300. Using EPS techniques, the CPU 320 processes the data in accordance with instructions received from the user via an input device 310 and GUI 400 to produce a detail-in-context presentation. The presentation is presented to the user on a display screen 340. It will be understood that the CPU 320 may apply a transformation to the shoulder region 430 surrounding the region-of-interest 420 to affect blending or folding in accordance with EPS technology. For example, the transformation may map the region-of-interest 420 and/or shoulder region 430 to a predefined lens surface, defined by a transformation or distortion function and having a variety of shapes, using EPS techniques. Or, the lens 410 may be simply coextensive with the region-of-interest 420.

The lens control elements of the GUI 400 are adjusted by the user via an input device 310 to control the characteristics of the lens 410 in the detail-in-context presentation. Using an input device 310 such as a mouse, a user adjusts parameters of the lens 410 using icons and scroll bars of the GUI 400 that are displayed over the lens 410 on the display screen 340. The user may also adjust parameters of the image of the full scene. Signals representing input device 310 movements and selections are transmitted to the CPU 320 of the data processing system 300 where they are translated into instructions for lens control.

Moreover, the lens 410 may be added to the presentation before or after the object or area is selected. That is, the user may first add a lens 410 to a presentation or the user may move a pre-existing lens into place over the selected object or area. The lens 410 may be introduced to the original image to form the presentation through the use of a pull-down menu selection, tool bar icon, etc.

Advantageously, by using a detail-in-context lens 410 to select an object or area for detailed information gathering, a user can view a large area (i.e., outside the extent 412 of the lens 410) while focusing in on a smaller area (or within the focal region 420 of the lens 410) surrounding the selected object. This makes it possible for a user to accurately gather detailed information without losing visibility or context of the portion of the original image surrounding the selected object.

Now, there has been an increase in the availability of online and interactive presentations of digital maps and geographically relevant photographic images. In addition, there has been a rise in the use of search engines such as Yahoo™ and Google™ for finding information on the Internet and on local computers. Search engines and online map presentations have also been combined in order to provide new capabilities such as location-specific searching and location-based advertising. Map services also commonly provide graphical and text based enhancements such as online driving directions. However, as discussed above, important local details in such maps are often not visible without the loss of surrounding or global location information. This can be problematic in that, for example, global increases in magnification tend to hide information and disorient the user. Detail-in-context lensing (e.g., U.S. Pat. No. 6,768,497 to Baar et al., which is incorporated herein by reference) provides means to overcome these problems and to improve the usability of online mapping applications, while at the same time providing new opportunities for advertising revenue. However, implementing interactive detail-in-context lensing online is challenging. In the following, methods for implementing detail-in-context lensing for interactive online mapping and location-specific advertising are described.

Google Maps™ is an online interactive mapping service accessed via a web browser. It is presently in public beta testing. Key to its appeal is its user interface design and interactive performance. For example, smooth map scrolling and proper labelling are attributes that contribute to the usability to Google Maps™. Google Maps™ also has the capability of displaying satellite images, as well as maps, and of performing searches that result in addresses of locations (or regions) of interest. In some cases, these locations-of-interest may be shown on a map.

The architecture behind Google Maps™ has been given a name, AJAX™, which stands for “Asynchronous JavaScript And XML.” Google Maps™ runs JavaScript™ on the client side, and as required sends requests to the Google™ servers. These requests are standard hypertext transfer protocol (“HTTP”) requests, and in response Google™ servers send either images (e.g., joint photographic experts group (“JPG”) or graphic interchange format (“GIF”)) or extensible markup language (“XML”) documents. The images are in response to map/photo tile requests, and the XML documents are in response to search requests. JavaScript™ handles all drawing and user interaction with the map. Google Maps™ currently has two types of data, namely, map and photo data. These two sets of data are both accessed as square tiles, but are generally from different sources, and use different indexing schemes. The map data is accessed using a 3-tuple index, namely, an x tile coordinate, ay tile coordinate, and a zoom level. Each zoom level is a factor of 2 larger or smaller compared with the next zoom level. The photo data is accessed using a single string combination of the letters ‘q’, ‘r’, ‘s’, and ‘t.’ An example string would be ‘qtssstrqs.’ Each individual letter specifies a tile from a quadrant in a square, and each successive letter specifies a finer sub-quadrant in a sub-quadrant. Thus, the more letters in a string, the more that the image is zoomed in, and the more magnified the tile is. Converting between map tile coordinates and photo tile coordinates is possible. It should be noted that there is also a third relevant coordinate pair, latitude and longitude, which is used for returned search results.

Now, in accordance with the present invention, detail-in-context lensing capabilities (e.g., U.S. Patent Application Publication No. 2004/0111332 by Baar et al., which is incorporated herein by reference) are adapted for application to mapping services such as Google Maps™ for the purpose of improving the usability of these services, adding new functionality, and providing for the insertion of new content such as advertising.

Consider first the integration of detail-in-context lensing into the server-side architecture of a tiled map presentation service such as Google Maps™. A server-side implementation is desirable since with such an implementation little or no software has to be installed on the client computer beyond an Internet browser such as Internet Explorer™ or Mozilla Firefox™. Described below are two methods for applying detail-in-context lensing on the server side, namely, a static method and a dynamic method. Each method provides the client with lensed tiles for lensed map presentations.

With respect to the static method for applying detail-in-context lenses to a tiled original image, first, assume that a map server (or servers) stores pre-rendered map and photo tiles for an original image. In order to provide lensed tiles in this case, static lensed tiles are also stored on the server (or servers). With the tiles stored on the server, the server is only required to serve the right lensed tiles to the right user. This requires no lens rendering on the server side, which is advantageous. One drawback to this method is that it is expensive, in terms of memory, to store all possible lensed tiles on the server. However, this drawback can be alleviated according to the present invention by restricting lens locations and sizes. According to one embodiment, the focal region 420 of a lens 410 may be centered on and covering a single tile with the shoulder region 430 overlapping exactly one tile in all directions surrounding the focal region 420. This would require that there to be eight (8) additional tiles stored for each current tile in the original image, one for each of the eight directions (i.e., 45 degrees apart) from the focal region. A tile for the focal region 420 would not need to be stored if the lens was at a factor of two (2) in magnification as the appropriate tile would simply be from the next magnification level up which would likely already be stored on the server. This would save memory at the server. According to another embodiment, a quasi-static or locally-static method is provided in which lensed tiles are rendered and stored only for a current map coverage area or that coverage area plus a surrounding buffer zone. According to another embodiment, lensed tiles may be maintained in storage at the server mainly for (or only for) frequently requested coverage areas of maps such as major cities.

With respect to the dynamic method for applying detail-in-context lenses to a tiled original image, an application residing on a server is provided that dynamically produces lensed versions of tiles. These lensed tiles or images are then served to clients (i.e., to client applications). One advantage of this dynamic method is that little or no additional storage is required at the server, plus any arbitrary lensing can be accommodated (i.e., there need be no restriction on lens position or shape). One drawback is that computation time at the server would be required to perform the lensing, but the storage requirements of the static method described above would be reduced.

Accordingly, this dynamic method may be most suitable to lensing for a typical map server implementation.

The present invention also provides for applying detail-in-context lenses to a non-tiled original image provided by a map server. In the case of map presentations in which the whole map is presented as a single raster image rather than as a number of tile images, an alternate approach is to pre-place detail-in-context lenses 410 on an original map image prior to serving it to the client, and then serve the entire map presentation area to the client with the lenses “burned-in” to the map. This approach does not directly allow the user to interact with a map, but nonetheless can be used to draw the user's attention to features or regions-of-interest within the map. Interactivity may be added through the use of “rollover” functions in which the map display is toggled from a lensed to an unlensed state, or through the use of hyptertext markup language (“HTML”) image maps to allow for redrawing of just the lensed area, or to define regions-of-interest either within lenses or identical with the lens coverage area.

According to one embodiment, the above static, dynamic, and non-tiled mapping methods may be provided through a lensing proxy service. In this embodiment, map requests are received by a proxy server with lensing capabilities. The proxy server requests appropriate tiles or images from the primary or content map server and performs lensing operations on these tiles or images based on the desired magnification and geographic location of the lens. According to one embodiment, proxy server lensing may be provided as a for-pay web service which may be applied not only to maps but also to other forms of data (e.g., general images, text, etc.).

FIG. 5 is a screen capture illustrating a detail-in-context presentation 500 in which a lens 410 is coupled to search results 520 and is applied to an online map in accordance with an embodiment of the invention. According to one embodiment, detail-in-context lensing may be combined with Google™ search results to provide users with several advantages. First, lenses can be used to freely investigate content or regions-of-interest 595 in a view, representation, or original image. The view may be either map data or photo data, as the two can be selected independently in either the lens 410 or the context 590 surrounding the lens 410. In addition, the lens 410 can be used to view location search results 520. When performing a search for “pizza” parlours, for example, the map server 300 may return search results including a list of locations 520. This list 520 may be displayed in a search results window 510 of the presentation 500 adjacent to a map window 540 containing an associated map presentation 550. For each search result or item (e.g., 530) in the list 520, information including the following may be presented: an address, latitude/longitude coordinates, phone number(s), name(s), a distance from a currently centered location within the map presentation 550, and links to content reviews or other sources of information. In the screen capture of FIG. 5, the presentation 500 shows the list of locations (i.e., the search results) 520 and basic related data (e.g., the address of each pizza parlour found by the search) in a bar or window 510 displayed to the right of an associated map presentation 550 which includes a detail-in-context lens 410. The user may select a search result or item (e.g., 530) in the list 520 which will cause the lens 410 to automatically center itself over the geographic location 560 of the selected item 530 in the map presentation 550. In FIG. 5, the selected item 530 is “Park's Garden Pizza” located at “430 Pender Street West, Vancouver, B.C.” This location may be marked with a circled dot icon 561 within the focal region 420 of the lens 410 in the map presentation 550. The locations (e.g., 580) of other non-selected items (e.g., 570) in the list 520 may be marked with dot icons (e.g., 581) in the map presentation 550. Of course, these icons 561, 581 may have any shape or design. Application of the lens 410 is advantageous for de-cluttering purposes when related search result locations (e.g., 560, 580) are very close together, which may frequently occur, as the lens 410 magnifies only the region surrounding the selected location 560. As mentioned, other related information, such as telephone numbers and reviews, may be incorporated into the presentation 500.

According to one embodiment, when a path defining driving directions to a selected location (e.g., 560) from a given starting point is available, the path (not shown) may be overlaid on the map 550 and the location of the lens 410 within the map 550 may be constrained (or limited) to points lying on the path. In this case, the user may drag the lens 410 along the path to reveal details. According to another embodiment, critical decision points (e.g., street intersections) may be displayed in a location bar or window (not shown) adjacent to the map window 540 and the user may be allowed to position the lens 410 over these points only. In each of these cases, the centroid (or focal region 420) of the lens 410 or another fixed point on the lens 410 is constrained to one or more fixed points (e.g., intersections) or to a path defined by a polyline.

According to another embodiment, the above described constraints may be selectively relaxed. For example, a user may wish to explore an area in the vicinity of a specific item or region-of-interest 595, such as the neighbourhood or street details near a house or business shown on a digital map. In this case, a lens 410 located at location x may be allowed to travel on demand (i.e., to be positioned) up to a distance δ away from x. Alternatively, the lens 410 may be constrained such that it is moveable only within a polygon containing x. Similarly, for the case of a path-of-interest, such as the path to be navigated on a street map between a starting point and a destination, movement of the lens 410 may be constrained to the path or up to a distance δ from the path. According to another embodiment, the lens 410 may be allowed to expand in extent (i.e., the area covered by the lens 410) to cover an area in the vicinity of a point x on a map, or to expand so as to cover a larger area in the vicinity of a constraining path on the map, if this is desired by the user or the map presenter.

According to another embodiment, the location x of a lens 410 on a map presentation (e.g., 550) may be set or determined based on the current location of a user. The current location of the user may be obtained from a global positioning system (“GPS”) receiver (not shown) coupled to the data processing system 300. In this case, movement of the lens 410 may be limited or constrained to a distance ε from the current location of the user. Limiting the possible lens locations to within ε of x can prevent user errors such as accidentally causing the map display area to exclude the current location x. According to another embodiment, multiple lenses may be positioned at or near the start and end points of a trip or path shown on a map. According to another embodiment, an animation is provided in which a lens 410 or lenses traverse a defined route or path for a trip as shown on a map as a function of time.

Now, detail-in-context lenses provide a highlighting of areas or regions-of-interest (e.g., 595) in that each region-of-interest 595 is magnified by a lens 410 and hence is made more prominent for the user. The user's attention can be drawn to the region-of-interest 595 in this way. Thus, as described above, lenses can be used to highlight locations or search results found from search queries. In the case of where the search results includes multiple items such as the list 520 of pizza parlours 530, 570 found by the search for “pizza” as illustrated in FIG. 5, a lens 410 may be presented over an area or region of the map corresponding to a search hit or item (e.g., 530) that is selected by the user with a pointing device 310 or, alternatively, that is selected on the basis of achieving a high ranking from the search engine. According to one embodiment, lenses 410 may be presented over advertising content in digital maps, for example, to make that content more prominent. The advertiser may pay increased fees to have such lenses presented over their advertising content.

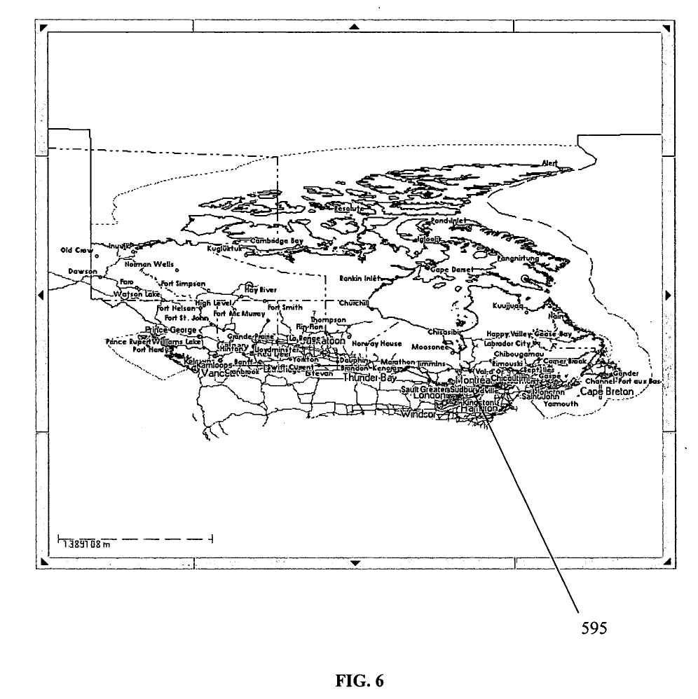

FIG. 6 is a screen capture illustrating an online map 600 having cluttered data (e.g., boundaries, etc.) and labels (e.g., “Montreal”, etc.) in accordance with an embodiment of the invention. And, FIG. 7 is a screen capture illustrating a detail-in-context presentation 700 of the online map 600 of FIG. 6 in which de-cluttering is provided in the lens 410 in accordance with an embodiment of the invention. Detail-in-context lenses 410 provide a de-cluttering capability that can allow for local insertion of new content in the lens 410 when it is applied to representation such as an online map 600. For example, in the online map 600 of Canada shown in FIG. 6, the data and labels are dense and cluttered in the region 595 around the city of Montreal. However, the presence of a lens 410 over this region-of-interest 595 as shown in the detail-in-context presentation 700 of FIG. 7 has increased locally the amount of blank space 710 that is interstitial with the data and labels. According to one embodiment, this increase in local blank space 710 allows for the insertion of new content into the presentation 700 such as new information relevant to the region-of-interest 595 or new advertising content.

In some cases, the user may be provided with the capability of interactively moving lenses 410 in a map presentation 700. In such cases, the positioning of a lens 410 by a user on a particular region or location 595 indicates that the user is interested in that location (i.e., it is a region-of-interest). According to one embodiment, recording the locations of a lens 410 positioned by a user in an online map presentation 700, for example with text files (i.e., “cookies”) on the client computer or alternately on the server computer, is provided to allow interest in a particular region 595 over which the lens 410 is positioned to be subsequently studied. Such a study may examine the effectiveness of advertising content associated with the region 595, for example.

As described above, a detail-in-context lens 410 allows for additional detail or content (e.g., within blank spaces 710) to be shown in the focal region 420 of the lens 410, such as street name labels (e.g., “Pender St.”), city name labels (e.g., “Montreal”), and other geographic labels as shown in FIGS. 5 and 7. According to one embodiment, labels (e.g., street names, city names, etc.) appearing in a region-of-interest (e.g., 595) in an online map (e.g., 600) are relocated when a lens 410 is applied to the map 600 to generate a detail-in-context presentation (e.g., 700) so that they appear entirely within the focal region 420 of the lens 410 hence providing optimal text visibility to the user. Resizing of text fonts for the labels may also be performed. In this way, labels may be optimally placed and sized to improve legibility.

As is apparent from the above, detail-in-context lenses 410 provide a means of specifying a region-of-interest (e.g., 595). This can be useful for filtering search results in cases when there may be many more results than can be easily handled. For example, if a user searches for “pizza” parlours with their map view (e.g., 550) specifying all of New York City, the number of results will likely be very large, and they will be difficult to sort through. According to one embodiment, using a lens 410 a user can dynamically specify a region-of-interest 595 within the map view 550 to limit the search. The items 530, 570 (e.g., pizza parlour locations) included in the search results 520 can be filtered (e.g., in real-time) to include only those items 530, 570 that pertain to locations 560, 580 that are located within the focal region 420 or lens bounds 412 (i.e., 420, 430) of the lens 410.

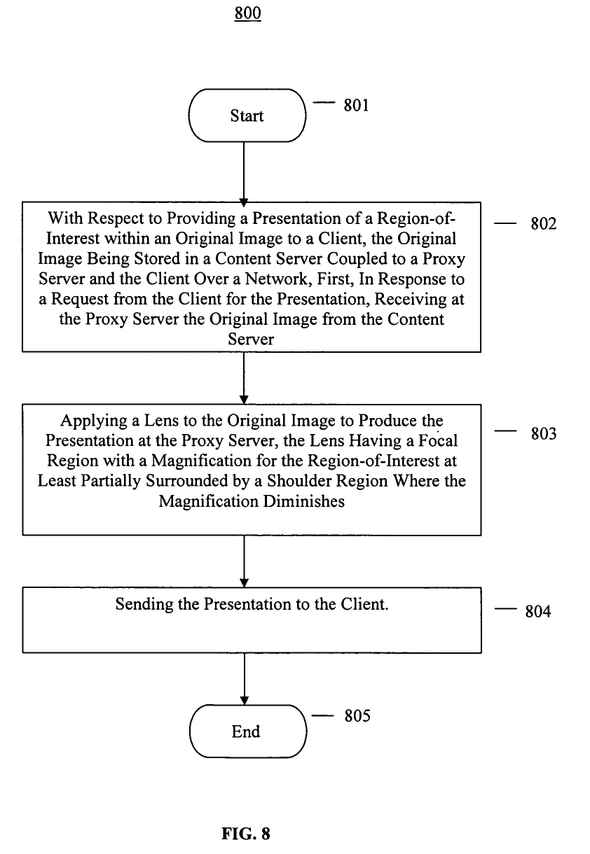

The above described method (i.e., with respect to the proxy server implementation) may be summarized with the aid of a flowchart. FIG. 8 is a flowchart illustrating operations 800 of modules 331 within the memory 330 of a proxy server 300 for providing a presentation (e.g., 700) of a region-of-interest (e.g., 595) within an original image (e.g., 600) to a client, the original image 600 being stored in a content server coupled to the proxy server and the client over a network, in accordance with an embodiment of the invention.

At step 801, the operations 800 start.

At step 802, in response to a request from the client for the presentation 700, the original image 600 from the content server is received at the proxy server 300.

At step 803, a lens 410 is applied to the original image 600 to produce the presentation 700 at the proxy server 300, the lens 410 having a focal region 420 with a magnification for the region-of-interest 595 at least partially surrounded by a shoulder region 430 where the magnification diminishes.

At step 804, the presentation 700 is sent to the client.

At step 805, the operations 800 end.

In the above method, the original image may include one or more tile images. The lens 410 may be applied to tile images corresponding to the region-of-interest 595 to produce lensed tile images and the presentation 700 may be produced by combining the lensed tile images with tile images corresponding to the original image beyond the region-of-interest (e.g., 590). The original image 600 may be a map image. The method may further include receiving one or more signals from the client to adjust the lens 410. The client may be adapted to display the presentation 700 on a display screen (e.g., 340). The step of applying may further include displacing the original image 600 onto the lens 410 to produce a displacement and perspectively projecting the displacement onto a plane 201 in a direction 231 aligned with a viewpoint 240 for the region-of-interest 595. The client may be adapted to receive the one or more signals through a graphical user interface (“GUI”) 400 displayed over the lens 410 in the presentation 700. The GUI 400 may have means for adjusting the lens 410 and at least some of the means may be icons (e.g., 440, 481, 482, 491, 740). And, the network may be the Internet, the content server may be a web browser server, and the client may be a web browser.

While this invention is primarily discussed as a method, a person of ordinary skill in the art will understand that the apparatus discussed above with reference to a data processing system (e.g., client, server, proxy server, content server, etc.) 300, may be programmed to enable the practice of the method of the invention. Moreover, an article of manufacture for use with a data processing system 300, such as a pre-recorded storage device or other similar computer readable medium including program instructions recorded thereon, may direct the data processing system 300 to facilitate the practice of the method of the invention. It is understood that such apparatus and articles of manufacture also come within the scope of the invention.

In particular, the sequences of instructions which when executed cause the method described herein to be performed by the data processing system 300 of FIG. 3 can be contained in a data carrier product according to one embodiment of the invention. This data carrier product can be loaded into and run by the data processing system 300 of FIG. 3. In addition, the sequences of instructions which when executed cause the method described herein to be performed by the data processing system 300 of FIG. 3 can be contained in a computer software product according to one embodiment of the invention. This computer software product can be loaded into and run by the data processing system 300 of FIG. 3. Moreover, the sequences of instructions which when executed cause the method described herein to be performed by the data processing system 300 of FIG. 3 can be contained in an integrated circuit product (e.g., a hardware module) including a coprocessor or memory according to one embodiment of the invention. This integrated circuit product can be installed in the data processing system 300 of FIG. 3.

The embodiments of the invention described above are intended to be exemplary only. Those skilled in the art will understand that various modifications of detail may be made to these embodiments, all of which come within the scope of the invention.

What is claimed is:

1. A method for providing a presentation of a region-of-interest within an original image to a client, the original image being stored in a content server coupled to a proxy server and the client over a network, the method comprising:
in response to a request from the client for the presentation, receiving at the proxy server the original image from the content server;
applying a lens to the original image to produce the presentation at the proxy server, the lens having a focal region with a magnification for the region-of-interest at least partially surrounded by a shoulder region where the magnification diminishes; and,
sending the presentation to the client.

2. The method of claim 1 wherein the original image includes one or more tile images.

3. The method of claim 2 wherein the lens is applied to tile images corresponding to the region-of-interest to produce lensed tile images and the presentation is produced by combining the lensed tile images with tile images corresponding to the original image beyond the region-of-interest.

4. The method of claim 3 wherein the original image is a map image.

5. The method of claim 1 and further comprising receiving one or more signals from the client to adjust the lens.

6. The method of claim 1 wherein the client is adapted to display the presentation on a display screen.

7. The method of claim 1 wherein the applying further comprises displacing the original image onto the lens to produce a displacement and perspectively projecting the displacement onto a plane in a direction aligned with a viewpoint for the region-of-interest.

8. The method of claim 5 wherein the client is adapted to receive the one or more signals through a graphical user interface (“GUI”) displayed over the lens in the presentation.

9. The method of claim 8 wherein the GUI has means for adjusting the lens and wherein at least some of the means are icons.

10. The method of claim 1 wherein the network is the Internet, wherein the content server is a web browser server, and wherein the client is a web browser.

11. A method for generating a presentation of search results pertaining to a geographic area for display on a display screen, comprising:
receiving a signal selecting a search result from the search results, the search result having a location within the geographic area; and,
applying a lens to an original map image for the geographic area to produce the presentation, the lens having a focal region with a magnification for the location at least partially surrounded by a shoulder region where the magnification diminishes.

12. The method of claim 11 and further comprising displaying the presentation on the display screen.

13. The method of claim 11 and further comprising inserting an icon into the presentation at the location to highlight the location.

14. The method of claim 11 wherein the original map image is an online map image.

15. The method of claim 12 wherein the presentation is displayed in a first window on the display screen and the search results are displayed in a second window on the display screen.

16. The method of claim 11 wherein the original map image includes one or more text labels and further comprising relocating at least one text label appearing within the lens to within the focal region of the lens to improve legibility of the at least one text label.

17. The method of claim 16 and further comprising adjusting a font size of the at least one text label within the focal region to improve legibility of the at least one text label.

18. The method of claim 11 wherein the signal is received from a pointing device manipulated by a user.

19. The method of claim 11 wherein the signal is generated from a ranking of the search results.

20. The method of claim 11 and further comprising inserting information pertaining to the search result into the presentation within the lens.

21. The method of claim 20 wherein the information is one or more of a text message, a telephone number, an email address, an advertisement, and a street address.

22. The method of claim 11 and further comprising receiving one or more signals to adjust at least one of a size, a shape, and the magnification of the focal region.

23. The method of claim 22 and further comprising receiving the one or more signals through a graphical user interface (“GUI”) displayed over the lens.

24. The method of claim 23 wherein the GUI has means for adjusting at least one of the size, shape, and magnification of the focal region.

25. The method of claim 24 wherein at least some of the means are icons.

26. The method of claim 25 wherein the means for adjusting the size and shape is at least one handle icon positioned on a perimeter of the focal region.

27. The method of claim 25 wherein the means for adjusting the magnification is a slide bar icon.

28. The method of claim 11 and further comprising receiving one or more signals through a GUI displayed over the lens to adjust at least one of a size and a shape of the shoulder region, wherein the GUI has one or more handle icons positioned on a perimeter of the shoulder region for adjusting at least one of the size and the shape of the shoulder region.

29. The method of claim 11 wherein the applying further comprises displacing the original map image onto the lens to produce a displacement and perspectively projecting the displacement onto a plane in a direction aligned with a viewpoint for the region-of-interest.

30. The method of claim 11 wherein the search results are generated by an online search engine.

31. A method for generating a presentation of a path from a first location to a second location in a geographic area for display on a display screen, comprising:
displaying an original map image for the geographic area having an overlaid representation of the path;
receiving a signal selecting a location on the original map image, wherein the location is limited to at least one of being on the representation of the path and being within a predetermined distance from the representation of the path; and,
applying a lens to the original map image to produce the presentation, the lens having a focal region with a magnification for the location at least partially surrounded by a shoulder region where the magnification diminishes.

32. The method of claim 31 and further comprising displaying the presentation on the display screen.

33. The method of claim 32 wherein the signal is received from a global positioning system (“GPS”) receiver.

34. The method of claim 32 wherein the signal is received from a pointing device manipulated by a user.

35. The method of claim 32 wherein the signal is a sequence of signals for moving the lens through a respective sequence of locations.

36. The method of claim 31 wherein the applying further comprises displacing the original map image onto the lens to produce a displacement and perspectively projecting the displacement onto a plane in a direction aligned with a viewpoint for the location.

37. The method of claim 31 and further comprising receiving one or more signals to adjust the lens through a graphical user interface (“GUI”) displayed over the lens, wherein the GUI has means for adjusting at least one of a size, a shape, and the magnification of the focal region, wherein the means for adjusting the size and shape is at least one handle icon positioned on a perimeter of the focal region, and wherein the means for adjusting the magnification is a slide bar icon.

38. The method of claim 37 and further comprising receiving one or more signals through the GUI to adjust at least one of a size and a shape of the shoulder region, wherein the GUI has one or more handle icons positioned on a perimeter of the shoulder region for adjusting at least one of the size and the shape of the shoulder region.

39. The method of claim 31 wherein the location is limited to at least one of being on a representation of a street intersection on the original map image or being within a predetermined distance from the representation of the street intersection on the original map image.

40. The method of claim 39 wherein the signal is received from a pointing device manipulated by a user over a listing of street intersections including an item corresponding to the representation of the street intersection.
